(19) United States
(12) Patent Application Publication
(10) Pub. No.: US 2012/0151175 A1
(43) Pub. Date: Jun. 14, 2012

(54) MEMORY APPARATUS FOR COLLECTIVE VOLUME MEMORY AND METHOD FOR MANAGING METADATA THEREOF

(75) Inventors: Young Ho KIM, Daejeon (KR); Eun Ji Lim, Daejeon (KR); Gyu II Cha, Daejeon (KR); Dong Jae Kang, Daejeon (KR); Sung In Jung, Daejeon (KR)

(73) Assignee: Electronics and Telecommunications Research Institute, Daejeon (KR)

(21) Appl. No.: 13/310,057

(22) Filed: Dec. 2, 2011

(30) Foreign Application Priority Data
Dec. 8, 2010 (KR) 10-2010-0125132

(51) Int. Cl. G06F 12/02

(52) U.S. Cl. 711/171; 711/170; 711/E12.002

(57) ABSTRACT

Disclosed are a memory apparatus for a collective volume memory and a method for managing metadata thereof. The memory apparatus for a collective volume memory includes a CVM (Collective Volume Memory) command tool configured to provide a command tool for CVM operation and translate a command input by a user to control the CVM operation; and a CVM engine configured to perform at least one of CVM configuration and initialization, and CVM allocation and access according to data transmitted from the CVM command tool.

### CROSS-REFERENCE TO RELATED APPLICATIONS

This application claims priority to and the benefit of Korean Patent Application No. 10-2010-0125132 filed in the Korean Intellectual Property Office on Dec. 8, 2010, the entire contents of which are incorporated herein by reference.

### TECHNICAL FIELD

The present invention relates to a memory apparatus for a collective volume memory and a method for managing metadata thereof. More specifically, the present invention relates to a memory apparatus for a collective volume memory and a method for managing metadata thereof that are capable of improving scalability and the performance by minimizing a storage space and a status changing overhead under the environment where respective nodes configuring a cluster system operate using independent operating systems.

### BACKGROUND

A distributed/parallel computing environment that is a mainstream in a high performance computing (HPC) field is a cluster system. The collective volume memory (abbreviated to CVM) basically depends on a high performance cluster system in order to overcome the limitation of a physical memory of a single node and provide a large memory to a user. Especially, in the collective volume memory, it is very important to maximize linear scalability of a cluster system by minimizing an operational dependence between nodes of a high performance cluster system.

Generally, system failure frequently occurs in the cluster system in which a collective volume memory service is used. If an error occurs in a specific node of the cluster system, the specific node is separated from the entire cluster system and then an error recovery process should be performed. In order to support the recovery process, the collective volume memory should dynamically remove a contribution memory (abbreviated to CM) of a corresponding node that is performing collective virtualization from the CVM. Further, there may be a situation that in case of shortage of a private memory (abbreviated to PM) of the specific node, a CM of a node that is currently being used should be retrieved.

Meanwhile, a memory virtualization system that provides a collective volume memory in a cluster environment can be classified into two types. The first type of memory virtualization system is a system of managing available resources of all computing nodes including a memory by configuring all nodes as a single system. The second type of memory virtualization system is a system of providing collective virtualization for only a memory with operating systems that independently operate for every node. The first type has advantages such as excellent performance and easy management, but has a limitation on scalability. In contrast, according to the second type, the performance is worse than the first type and the management is a little bit complicated, but it is suitable for various applications and scalability is excellent.

If only the collective virtualization for a memory is provided as the second type, according to a conventional method, metadata is required for every allocation unit of a memory. According to a system with this configuration, the demands for a storage space of metadata required to manage the allocation status for a memory block increases in proportion to the number of nodes that configure a cluster. Therefore, there may be a problem in that the overhead of storage for metadata is increased in proportion to the number of configuration nodes. Further, if the allocation status for memory spaces such as allocation and deallocation is changed, the allocation status of a management block should be changed, which results in the increase of overhead in proportion to the capacity of requested memory. Due to the above-described problems, the scalability of a cluster system that provides a collective volume memory is limited and the overhead and the degradation of the performance of storage occur.

### SUMMARY

The present invention has been made in an effort to provide a memory apparatus for a collective volume memory and a method for managing metadata thereof that are capable of improving scalability and the performance by minimizing a storage space and a status changing overhead under the environment where respective nodes configuring a cluster system operate using independent operating systems.

An exemplary embodiment of the present invention provides a memory apparatus for a collective volume memory, including: a CVM (Collective Volume Memory) command tool configured to provide a command tool for CVM operation and translate a command input by a user to control the CVM operation; and a CVM engine configured to perform at least one of CVM configuration and initialization, and CVM allocation and access according to data transmitted from the CVM command tool.

Another exemplary embodiment of the present invention provides a method for managing metadata, including: determining whether reconfiguration is caused by addition or deletion of a node if there is a request to dynamically reconfigure a CVM; determining whether the reconfiguration is performed to change a CM size if the reconfiguration is not caused by the addition or deletion of the node; changing statuses of a corresponding local node and a master node if the reconfiguration is to performed to change the CM size; changing metadata of the local node; changing metadata relating to the local node in the master node; and changing the statuses of the local node and the master node to a normal operation status.

Yet another exemplary embodiment of the present invention provides a method for managing metadata, including: comparing an requested allocation size with a size of a free space of a CVM local status information table of a local node if there is a request to allocate a memory with a predetermined size in the local node; confirming that the status of the local node is available for allocation if it is possible to allocate the memory for the requested allocation size in the local node; allocating a memory block with an requested allocation size if the status of the local node is available for allocation; changing information concerning the memory allocation in a CVM allocation map and a CVM local status information table of the local node; and changing information concerning the memory allocation of the local node in a CVM allocation status information table of a master node.

According to exemplary embodiments of the present invention, it is possible to minimize a metadata storage overhead and a change reflection delay overhead of a local node and a master node for a collective volume memory of a cluster environment. Further, since there is little restriction of metadata change delay restriction of a storage space in view of the number of nodes, it is possible to improve the performance of memory service and cluster scalability even in the cluster environment that is configured by a large number of nodes, such as HPC.

In addition, since dynamic reconfiguration of a private memory and a contribution memory of nodes is supported, the demands for diversely applicable memory service can be satisfied. Specifically, since the modification of the capacity of a private memory and a contribution memory that configures a collective volume memory is dynamically supported, it is possible to configure memory that corresponds to the demands for application during the system operation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram showing a collective volume memory system of a cluster environment.

FIG. 2 is a configuration diagram of a memory apparatus that configures a collective volume memory system according to an exemplary embodiment of the present invention.

FIG. 3 is a diagram showing a metadata operating structure of a collective volume memory system according to an exemplary embodiment of the present invention.

FIGS. 4A to 4D are diagrams showing examples metadata architecture of a collective volume memory system according to an exemplary embodiment of the present invention.

FIG. 5 is a flowchart showing a metadata management process when there is a request of dynamic reconfiguration of metadata of a collective volume memory according to an exemplary embodiment of the present invention.

FIG. 6 is a flowchart showing a metadata management process when there is a request for memory allocation of a collective volume memory according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereafter, exemplary embodiments of the present invention will be described in detail with reference to the accompanying drawings. First of all, it is to be noted that in giving reference numerals to elements of each drawing, like reference numerals refer to like elements even though like elements are shown in different drawings. Further, when it is determined that the detailed description related to a known configuration or function may render the purpose of the present invention unnecessarily ambiguous in describing the present invention, the detailed description will be omitted here. Further, the preferred embodiments of the present invention will be described hereinbelow, but it will be apparent to those skilled in the art that various modifications and changes may be made thereto without departing from the scope and spirit of the invention.

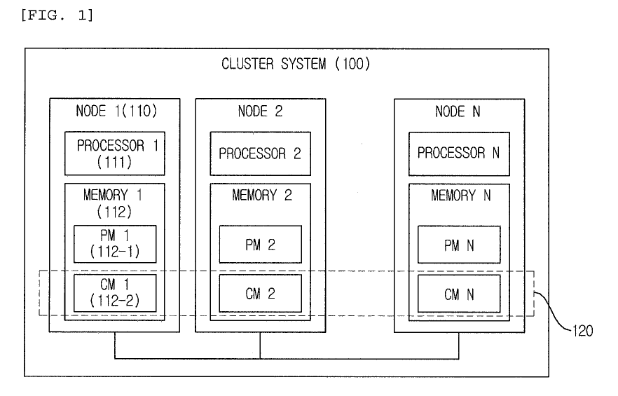

FIG. 1 is a configuration diagram showing a collective volume memory system of a cluster environment.

In a cluster system 100 that is connected to a low delay high speed network such as InfiniBand (IB), nodes 110 that include resources such as a processor 111 and a memory 112 are operated by operating systems that are independently installed.

A physical memory 112 of each node 110 is divided into a private memory (PM) 112-i that is operated by an operating system and a contribution memory (CM) 112-2 that configures a collective volume memory (CVM) 120 providing the combined area in a single memory virtual hierarchy form by combining specific areas distributed in the respective nodes 110.

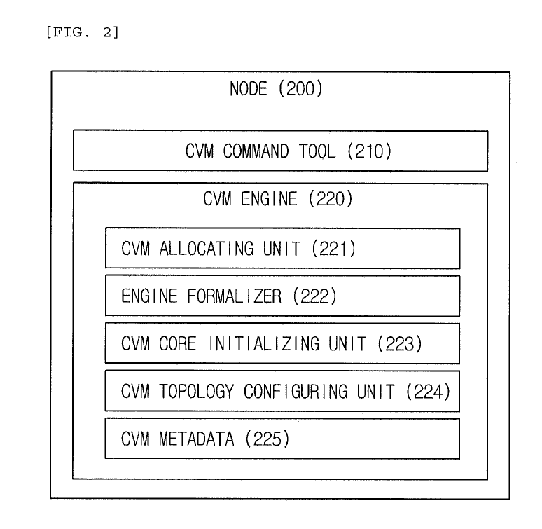

FIG. 2 is a configuration diagram of a memory apparatus that configures a collective volume memory system according to an exemplary embodiment of the present invention.

Referring to FIG. 2, each of the nodes 200, which independently operates, includes a CVM command tool 210 that is a command tool for providing a collective volume memory service and a CVM engine 220 that performs memory service and management such as CVM configuration, initialization, CVM allocation, and access.

The CVM command tool 210 provides a command tool for allowing a system user to operate the CVM and translates factors input by a user in connection with providing a collective volume memory service to transmit information required to perform to the CVM engine 220 and control to perform the operation. The system user uses the CVM command tool 210 to initialize the CVM engine 220 or manage a form of the CVM or indentify the status information on the CVM or the CM for each node.

The CVM engine 220 includes a CVM allocating unit 221, an engine formalizer 222, a CVM core initializing unit 223, and a CVM topology configuring unit 224, and maintains CVM metadata 225 in order to configure the CVM and manage the allocation status.

The CVM allocating unit 221 performs allocation and deallocation of a memory. Specifically, if the application program requests to allocate a memory, the CVM allocating unit 221 looks up an available memory of a node suitable to allocate the memory on the basis of the CVM allocation information. After the memory is allocated by the CVM allocating unit 221, the memory allocation information is updated by the CVM metadata 225. Further, if there is a deallocation request for the allocated memory, the CVM allocation information is modified by the CVM allocating unit 221 and the memory is deallocated.

The engine formalizer 222 transmits the data transmitted from the CVM command tool 210 to the CVM core initializing unit 223 and the CVM topology configuring unit 224 to perform initialization of a CVM core, management of the shape of CVM, and booting of the CVM engine 220.

The CVM core initializing unit 223 initializes all data structure that is maintained in the CVM core based on the data transmitted from the engine formalizer 222 and format its own local CM, and then performs the management of the shape of the entire CVM using the CVM topology configuring unit 224.

The CVM topology configuring unit 224 performs management of metadata related with the CVM configuration.

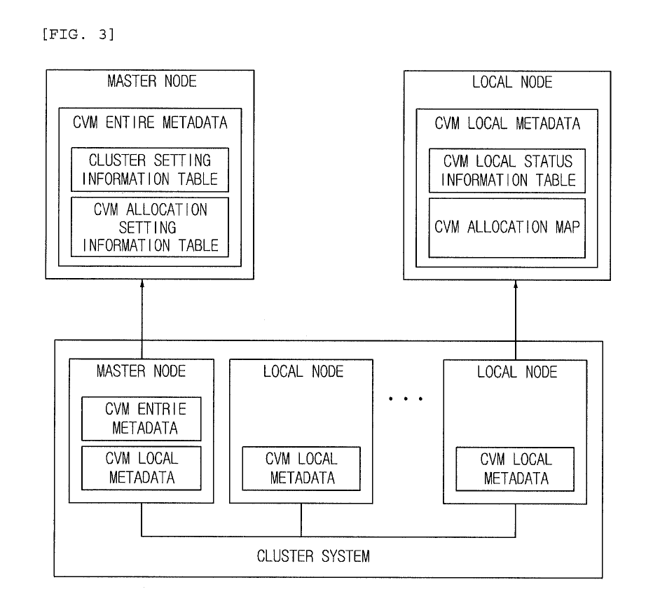

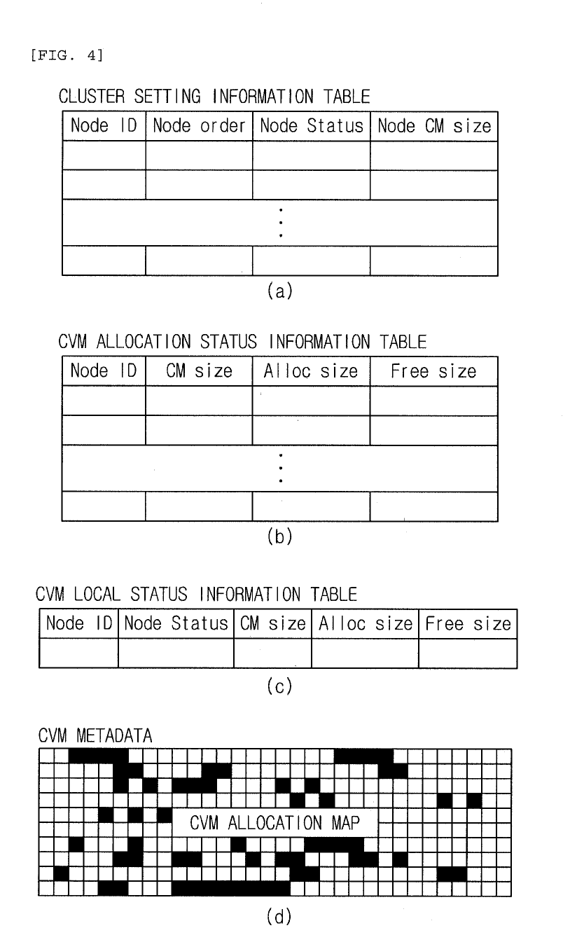

FIG. 3 is a diagram showing a metadata operating structure of a collective volume memory system according to an exemplary embodiment of the present invention, and FIGS. 4A to 4D are diagrams showing examples of metadata architecture of a collective volume memory system according to an exemplary embodiment of the present invention.

As described above, all nodes that configure the cluster system in order to provide a collective volume memory service maintains the CVM metadata for the CVM configuration and allocation status management. The CVM metadata includes a CVM entire metadata for managing the entire configuration of the cluster system and a CVM allocation status and a CVM local metadata for managing a setting and allocation status information of the respective nodes. One of the nodes that configure the cluster system is served as a master node that manages the CVM entire metadata.

The CVM entire metadata includes a cluster setting information table and a CVM allocation status information table. The cluster setting information table and the CVM allocation status information table include entries as many as the number of nodes that configure the cluster system.

FIG. 4A and FIG. 4B show examples of the cluster setting information table and the CVM allocation status information table, respectively. The cluster setting information table may include items such as a node ID, a node order, a node status, and a node CM size for every node. Further, the CVM allocation status information table may include items such as a node ID, a CM size, a size of an allocation space, and a size of a free space for every node.

According to the exemplary embodiment, the CVM allocation status information table is used at the time of requesting memory allocation. However, since a node that is available for allocation of a memory is searched by comparing a size of a free space of a node, delay of searching time is minimized.

Further, since the master node does not maintain the allocation status information for every memory block, the overhead of the storage space can hardly occur even though the number of nodes that configure the cluster is increased. According to the exemplary embodiment, the request for a storage space of a metadata that occurs when a node is added is limited to several tens of bytes, which is a size of an entry added to the CVM allocation information table.

In the meantime, the CVM local metadata includes a CVM local status information table for managing a status of a local node that configures the cluster system and a CVM allocation map for indicating an allocation status of a memory block that configures the CM.

FIGS. 4C and 4D show examples of a CVM local status information table and a CVM allocation map, respectively. The CVM local status information table may include items such as a node ID, a node status, a CM size, a size of allocation space, and a size of a free space for a corresponding local node. Further, the CVM allocation map represents the memory allocation status as a bitmap. Therefore, since only one bit is required to indicate the memory allocation status, the storage overhead of the metadata is minimized and the status change and search are performed by a bit operation, which allows improvement in the processing performance.

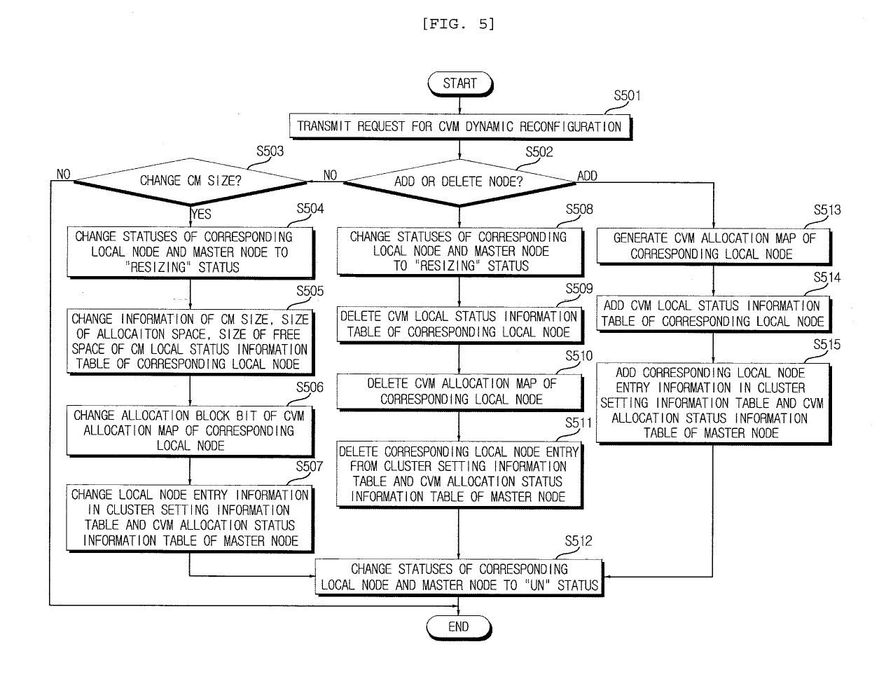

FIG. 5 is a flowchart showing a metadata management process when there is a request of dynamic reconfiguration of metadata of a collective volume memory according to an exemplary embodiment of the present invention.

If a request for dynamic reconfiguration of a CVM is transferred to a CVM engine 220 through a CVM command tool 210 (S501), it is determined whether the reconfiguration is requested due to addition or deletion of a node (S502). In this case, the dynamic reconfiguration due to the addition or deletion of a node is generally caused by the extension of a cluster or system error recovery.

If it is determined that the reconfiguration is not due to the addition or the deletion of a node, it is determined whether the reconfiguration is requested for changing a CM size (S503). If it is determined that the reconfiguration request is for changing a CM size, the corresponding local node and the master node change their status to a “resizing status” (S504) to block the allocation or access to the corresponding CM area.

When the status change is completed, the information of the CM size, the size of allocation space, and the size of free space of the CVM local status information table of the local node is changed (S505), and the CVM allocation map is expanded or reduced in order to reflect the changed CM size (S506). Thereby, the change for the corresponding local node is completed.

When the change regarding the local node is completed, the master node reflects the change of the status information regarding the corresponding local node. In other words, the master node reflects the change of the CM size to the corresponding node entry of the cluster setting information table and the CVM allocation status information table of the master node (S507).

When the change of the master node is completed, the statuses of the local node and the master node are changed to “run” status that indicates the normal operation status (S512). If the node status change is completed as described above, the memory access and allocation of the corresponding node to the CM are normally performed.

In the meantime, if it is determined that reconfiguration is caused by deletion of a node, the statuses of the local node and the master node are changed to “resizing” status (S508), the CVM local status information table and the CVM allocation map of the local node are deleted (S509, S510), and then the node entry information is deleted from the cluster setting information table and the CVM allocation status information table of the master node (S511). Thereafter, the statuses of the local node and the master node are changed to “run” status (S512).

In contrast, if it is determined that the reconfiguration is caused by the addition of the node, a CVM allocation map of an corresponding local node is generated (S513), and a CVM local status information table of the local node is added (S514). Thereafter, entry information of the corresponding node is added to the cluster setting information table and the CVM allocation status information table of the master node (S515). Then, the node statuses of the local node and the master node are changed to “run” status (S512).

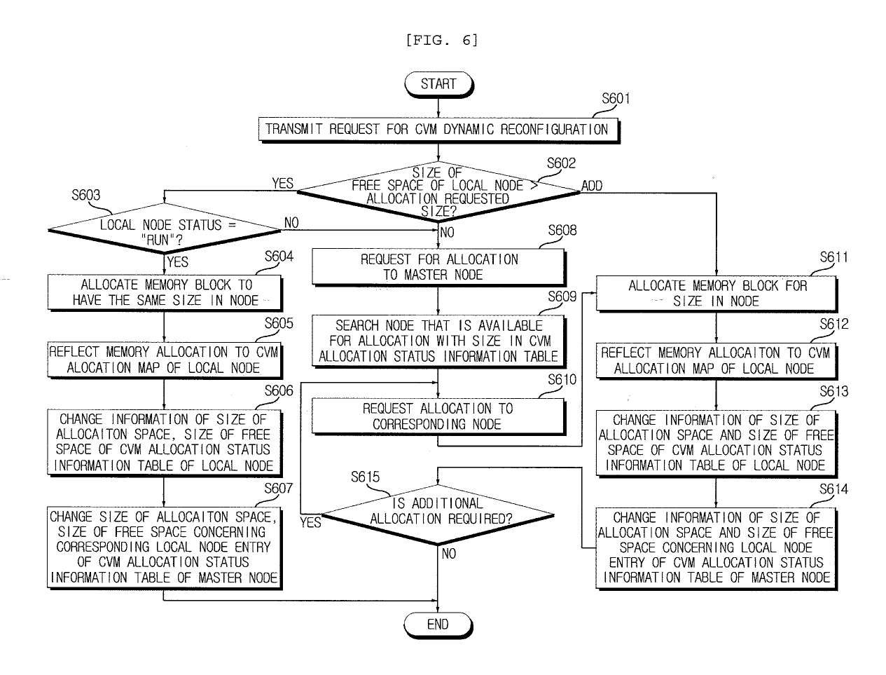

FIG. 6 is a flowchart showing a metadata management process when there is a request for memory allocation of a collective volume memory according to an exemplary embodiment of the present invention.

If a memory allocation request having the same size as the local node is generated in a local node (S601), it is determined whether the allocation is available in a CM area of the local node by comparing the size of a free space of the CVM local status information table of the local node with an requested allocation size (S602).

If there is sufficient space in the local node to allocate, it is confirmed whether the status of the local node is “run” status (S603).

If the status of the local node is “run”, a memory block is allocated to have the same size as the local node (S604), a bit of a block location allocated in the CVM allocation map of the local node is set to reflect the memory allocation to the CVM allocation map (S605), and information regarding the size of the allocation space and the size of the free space of the CVM local status information table is changed (S606).

If the change of the allocation status information of the local node is completed, the information of the size of the allocation space and the size of the free space for a corresponding local node entry is changed in the CVM allocation status information table of the master node (S607).

If the change of the allocation status information of the master node is completed, the request for memory allocation is normally completed.

In contrast, if the free space of the local node is smaller than the requested allocation size, or the status of the local node is not “run”, the memory allocation is requested to the master node (S608).

In the master node, a node that is available to allocate the memory is searched using information of the size of the free space of the node entry of the CVM allocation status information table (S609), and then a node to allocate the memory is selected to request the memory allocation to the corresponding node (S610).

The node to which memory allocation is requested allocates a memory block as described in the steps S604 and S607, and the memory allocation status change is reflected in the local node and the master node (S611 to S614).

If the memory allocation and the metadata reflection are completed in the node to which memory allocation is requested, the master node determines whether additional allocation is required in another node (S615). If another node requires additional allocation, the above steps S610 to S614 are repeatedly performed.

If allocation of the memory blocks to have the same size as the requested allocation size is completed, the processes are finished.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A memory apparatus for a collective volume memory, comprising:
a CVM (Collective Volume Memory) command tool configured to provide a command tool for CVM operation and translate a command input by a user to control the CVM operation; and
a CVM engine configured to perform at least one of CVM configuration and initialization, and CVM allocation and access according to data transmitted from the CVM command tool.

2. The memory apparatus of claim 1, wherein the CVM engine includes:
a CVM allocating unit configured to perform allocation and deallocation of a memory;
an engine formalizer configured to transmit the data transmitted from the CVM command tool to a CVM core initializing unit and a CVM topology configuring unit to perform at least one of CVM core initialization, CVM format management, and CVM engine booting;
a CVM core initializing unit configured to initialize data structure that is maintained in the CVM core based on the data transmitted from the engine formalizer, and format the local CM; and
a CVM topology configuring unit configured to perform the CVM shape management by exchanging information of a CM shape of all the nodes that configure a cluster system with the CVM core.

3. The memory apparatus of claim 1, wherein the CVM engine maintains a CVM metadata for CVM configuration and allocation status management.

4. The memory apparatus of claim 3, wherein the CVM metadata includes:
a CVM entire metadata configured to manage the entire configuration of the cluster system and a CVM allocation status; and
a CVM local metadata configured to manage a setting and allocation status information of nodes that configures the cluster system.

5. The memory apparatus of claim 4, wherein the CVM entire metadata is managed by one node among nodes configuring the cluster system, which operates as a master node.

6. The memory apparatus of claim 4, wherein the CVM entire metadata includes a cluster setting the information table and a CVM allocation status information table.

7. The memory apparatus of claim 6, wherein the cluster setting information table includes one or more items of a node ID, a node order, a node status, and a node CM size for every node.

8. The memory apparatus of claim 6, wherein the CVM allocation status information table includes one or more items of a node ID, a CM size, a size of allocation space, and a size of free space for every node.

9. The memory apparatus of claim 4, wherein the CVM local metadata includes:
a CVM local status information table for managing a status of a local node that configures the cluster system and allocation information; and
a CVM allocation map configured to indicate the allocation status of a memory block that configures the CM.

10. The memory apparatus of claim 9, wherein the CVM local status information table includes one or more items of a node ID, a node status, a CM size, a size of allocation space, and a size of free space for a corresponding local node.

11. The memory apparatus of claim 9, wherein the CVM allocation map indicates the memory allocation status as bitmap.

12. A method for managing metadata, comprising:
determining whether reconfiguration is caused by addition or deletion of a node if there is a request to dynamically reconfigure a CVM;
determining whether the reconfiguration is performed to change a CM size if the reconfiguration is not caused by the addition or deletion of the node;
changing statuses of a corresponding local node and a master node if the reconfiguration is to change the CM size;
changing metadata of the local node;
changing metadata relating to the local node in the master node; and
changing the statuses of the local node and the master node to a normal operation status.

13. The method of claim 12, wherein the changing of the metadata of the local node includes:
changing information concerning a CM size, a size of an allocation space, and a size of a free space of a CVM local status information table of the local node; and
changing a CVM allocation map of the local node to reflect a changed CM size.

14. The method of claim 12, wherein in the changing of the metadata concerning the local node in the master node, the information change by the change of the CM size is reflected to the local node entry of a cluster setting information table and a CVM allocation status information table of the master node.

15. The method of claim 12, wherein further comprising:
changing the statuses of the corresponding node and the master node if the reconfiguration is caused by the deletion of a node;
deleting a CVM local status information table and a CVM allocation map of the local node;
deleting local node entry information from a cluster setting information table and a CVM allocation status information table of the master node; and
changing the statuses of the local node and the master node to a normal operation status.

16. The method of claim 12, further comprising the steps of:
generating a CVM allocation map of the local node and adding a CVM local status information table if the reconfiguration is caused by the addition of a node;
adding local node entry information to a cluster setting information table and a CVM allocation status information table of the master node; and
changing the statuses of the local node and the master node to a normal operation status.

17. A method for managing metadata, comprising:
comparing an requested allocation size with a size of a free space of a CVM local status information table of a local node if there is a request to allocate a memory with a predetermined size in the local node;
confirming that the status of the local node is available for allocation if it is possible to allocate the memory for the requested allocation size in the local node;
allocating a memory block with an requested allocation size if the status of the local node is available for allocation;
changing information concerning the memory allocation in a CVM allocation map and a CVM local status information table of the local node; and
changing information concerning the memory allocation of the local node in a CVM allocation status information table of a master node.

18. The method of claim 17, further comprising:
requesting memory allocation to the master node if the memory allocation for the requested allocation size is not possible in the local node or the status of the local node is not available for the allocation;
allowing the master node to search a node that is available for memory allocation using information of a size of a free space of the CVM allocation status information table; and
requesting the memory allocation to a node that is available for the memory allocation.
